(19) United States
(12) Patent Application Publication
(10) Pub. No.: US 2012/0031080 A1
(43) Pub. Date: Feb. 9, 2012

(54) METHOD AND APPARATUS FOR PREDICTING PEAK TEMPERATURE IN A VEHICLE PARTICULATE FILTER

(75) Inventor: Patrick Barasa, Ann Arbor, MI (US)

(73) Assignee: GM GLOBAL TECHNOLOGY OPERATIONS, INC., Detroit, MI (US)

(21) Appl. No.: 12/851,779

(22) Filed: Aug. 6, 2010

(51) Int. Cl. F02D 43/00; F01N 3/00; F01N 3/023

(52) U.S. Cl. 60/285; 60/295; 60/274; 60/297

(57) ABSTRACT

A vehicle includes an internal combustion engine having an exhaust port, a regenerable particulate filter in fluid communication with the exhaust port, and a host machine which calculates a predicted peak temperature in the particulate filter. The host machine automatically executes a control action when the predicted peak temperature exceeds a calibrated threshold, thus preventing the peak temperature from being realized. A soot model may be used to estimate filter soot loads and corresponding burn rates, with the host machine extracting information from the soot model to calculate the predicted peak temperature. A system for use aboard the vehicle includes the particulate filter and host machine configured as noted above. A method for use aboard the vehicle includes calculating a predicted peak temperature in the particulate filter using the host machine, and automatically executing a control action when the predicted peak temperature exceeds a calibrated threshold.

### TECHNICAL FIELD

The present invention relates to a method and apparatus for predicting peak temperature in a particulate filter in a vehicle exhaust stream.

### BACKGROUND

Particulate filters are designed to remove microscopic particles of soot, ash, metal, and other suspended matter from an exhaust stream of a vehicle. Over time, the particulate matter accumulates on the substrate within the filter. In order to extend the life of the particulate filter and to further optimize engine functionality, some filters are designed to be selectively regenerated using heat.

Temperatures within the particulate filter can be temporarily increased to between approximately 450° C. to 600° C. by directly injecting and igniting fuel, either in the engine's cylinder chambers or in the exhaust stream upstream of the filter. The spike in exhaust gas temperature may be used in conjunction with a suitable catalyst, e.g., palladium or platinum, wherein the catalyst and heat act together to break down any accumulated particulate matter into relatively inert carbon soot via a simple exothermic oxidation process.

### SUMMARY

A vehicle as disclosed herein includes an engine, a regenerable particulate filter, and a host machine. The particulate filter receives an exhaust stream from the engine's exhaust port, in some embodiments via an upstream oxidation catalyst. The host machine calculates a predicted peak temperature that will be reached within the particulate filter under current vehicle operating conditions, i.e., absent any control actions. The host machine may predict the peak temperature in part by referencing one or more models and extracting required values, such as estimated filter soot loading rates and corresponding burn rates.

The host machine compares the predicted peak temperature to a calibrated threshold, recording a diagnostic code to reflect the result. The host machine may then automatically execute an engine control action or another suitable control action when the predicted peak temperature exceeds the threshold. In following the methodology set forth herein, the host machine may prevent the predicted peak temperature from being realized, thereby protecting the substrate of the particulate filter from temperature spikes exceeding the filter's test-verified thermal boundary.

A system and method are also provided for use aboard a vehicle. The system includes the particulate filter and host machine noted above. The host machine calculates a predicted peak temperature in the particulate filter, and automatically executes a control action when the predicted peak temperature exceeds a calibrated threshold.

The method may be embodied as an algorithm which is executable via the host machine. The method includes using the host machine to calculate a predicted peak temperature in the particulate filter using a model, e.g., a soot model and/or a thermal model which provide estimated soot loads, particulate filter qualities, and corresponding burn rates. The method may also include using the predicted peak temperature to initiate an engine management action or another suitable control action as needed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an internal combustion engine and a heat-regenerable particulate filter; and

FIG. 2 is a flow chart describing a method for predicting a peak temperature of the particulate filter used aboard the vehicle shown in FIG. 1.

### DESCRIPTION

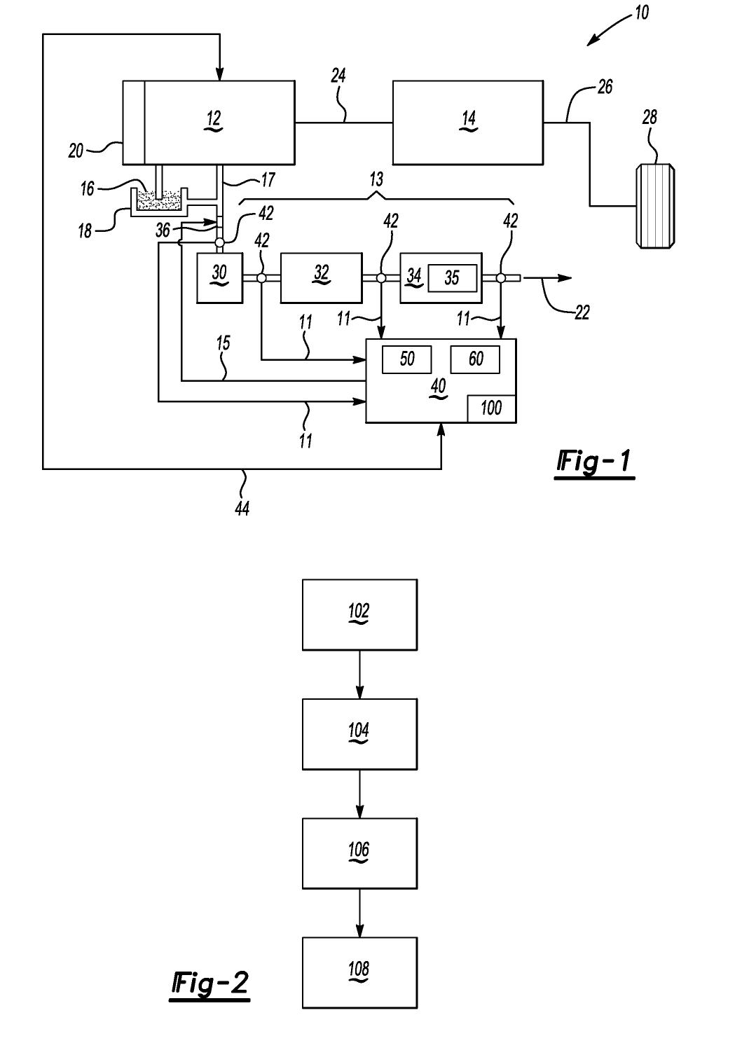

Referring to the drawings, wherein like reference numbers correspond to like or similar components throughout the several figures, a vehicle 10 is shown schematically in FIG. 1. Vehicle 10 includes a host machine 40 and an algorithm 100. Algorithm 100 may be selectively executed by host machine 40 in order to calculate a predicted peak temperature within an oxidation catalyst (OC) system 13 aboard the vehicle 10 under current vehicle operating conditions, and to thereafter prevent the predicted peak temperature from being realized in order to protect portions of the OC system from temperature spikes. Algorithm 100 is described in further detail below with reference to FIG. 2.

Vehicle 10 includes an internal combustion engine 12, such as a diesel engine or a direct injection gasoline engine, the OC system 13, and a transmission 14. Engine 12 combusts fuel 16 drawn from a fuel tank 18. In one possible embodiment, the fuel 16 is diesel fuel and the OC system 13 is a diesel oxidation catalyst (DOC) system, although other fuel types may be used depending on the design of the engine 12.

A throttle 20 may be used to selectively admit a mix of fuel 16 and air into the engine 12 as needed. Combustion of fuel 16 generates an exhaust stream 22, which is ultimately discharged into the surrounding atmosphere once filtered through the OC system 13. Energy released by the combustion of fuel 16 produces torque on an input member 24 of the transmission 14. The transmission 14 in turn transfers the torque from engine 12 to an output member 26 in order to propel the vehicle 10 via a set of wheels 28, only one of which is shown in FIG. 1 for simplicity.

OC system 13 cleans and conditions the exhaust stream 22 as it passes from an exhaust port(s) 17 of engine 12 through the vehicle's exhaust system. The OC system 13 may include an oxidation catalyst 30 and a particulate filter 34. According to one possible embodiment, the particulate filter 34 may be configured as a diesel particulate filter (DPF) when the fuel 16 is diesel fuel. An optional selective catalytic reduction (SCR) device 32 may be positioned between the oxidation catalyst 30 and the particulate filter 34 to convert nitrogen oxides (NOx) gasses into water and nitrogen as by products using an active catalyst, e.g., a ceramic brick or a ceramic honeycomb structure, a plate structure, or any other suitable design.

Particulate filter 34 is selectively regenerable using heat regardless of the composition of fuel 16. Regeneration of particulate filter 34 may be active or passive. As understood in the art, passive regeneration requires no additional control action for regeneration. Instead, the particulate filter 34 is installed in place of a muffler, and particulate matter is collected on a substrate within the filter at idle or low power operations. As exhaust temperature increases, the collected material within the particulate filter 34 is burned or oxidized by the exhaust stream 22. Active regeneration by contrast uses an external source of heat to aid regeneration, along with additional control methodology.

Still referring to FIG. 1, particulate filter 34 includes a substrate 35 which may be constructed of ceramic, metal mesh, pelletized alumina, or any other temperature and application-suitable material(s). As the engine exhaust stream temperature increases, the collected material in or on the substrate 35 of particulate filter 34 is burned or oxidized by the exhaust stream 22, as noted above. Some possible regeneration methods include coating the filter substrate 35 with a base or precious metal, thereby reducing the temperature needed for oxidation of the particulate matter, installing a catalyst such as oxidation catalyst 30 upstream of the particulate filter, using fuel-borne catalysts to reduce the burn-off temperature of the collected particulates, etc.

Particulate filter 34 may be connected to or formed integrally with the oxidation catalyst 30 in those embodiments in which the oxidation catalyst 30 is used. In other embodiments, a fuel injection device 36 may be placed in fluid communication with host machine 40 and controlled via control signals 15. Fuel injection device 36 selectively injects fuel 16 drawn from fuel tank 18 into the oxidation catalyst 30 or into engine cylinders (not shown) when determined by host machine 40. Injected fuel 16 is burned in a controlled manner in order to generate sufficient levels of heat for regenerating the particulate filter 34.

However, temperatures within the particulate filter 34 may at times reach levels exceeding a calibrated threshold. Therefore, host machine 40 is also configured to calculate a predicted peak temperature within the particulate filter 34 using temperature and soot modeling, and to take any necessary control actions preemptively in order to prevent the predicted peak temperature from being realized.

Host machine 40 may be configured as a digital computer acting as a vehicle controller, and/or as a proportional-integral-derivative (PID) controller device having a microprocessor or central processing unit (CPU), read-only memory (ROM), random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Algorithm 100 and any required reference calibrations are stored within or readily accessed by host machine 40 to provide the functionality described below with reference to FIG. 2.

Host machine 40 receives signals 11 from various sensors 42 positioned to measure exhaust qualities, e.g., temperature, pressure, oxygen level, etc., at different locations within OC system 13, including directly upstream and downstream of the oxidation catalyst 30 and the particulate filter 34. Host machine 40 is also in communication with the engine 12 to receive feedback signals 44 that identify current vehicle operating conditions, e.g., throttle position, engine speed, accelerator pedal position, fueling quantity, requested engine torque, etc.

Algorithm 100 may be executed by host machine 40 in order to calculate a predicted peak temperature within the particulate filter 34 under current vehicle operating conditions. Host machine 40 may reference a temperature model 50 and a soot model 60 in making this prediction, extracting calibrated information from each model as needed. Host machine 40 uses the rate of energy input into the substrate of the particulate filter 34, and the energy released and transferred into the substrate, i.e., by convection, oxidation of hydrocarbons and carbon soot, etc., with information from models 50 and 60, and then calculates a predicted peak temperature within the particulate filter 34.

Such an approach relies on the predictive accuracy of temperature and soot models 50, 60, respectively, and not on a use of the measured inlet temperature to the particulate filter 34 in a closed-loop feedback control process of the conventional mode. Host machine 40 compares the predicted peak temperature to a calibrated threshold. If the predicted peak temperature exceeds the threshold, the host machine may prevent the predicted peak temperature from being realized in various ways via one or more control actions.

Referring to FIG. 2, execution of algorithm 100 by host machine 40 calculates a predicted peak temperature, abbreviated T_{PF, PEAK}, inside of particulate filter 34 under current vehicle operating conditions so that the host machine 40 can preemptively request a suitable control action, thereby reducing the probability that the predicted peak temperature will ever be realized.

Algorithm 100 begins with step 102. At this step, the energy input rate \dot{Q}_{IN} into the OC system 13 is calculated by host machine 40 using the equation:

$${\dot{Q}}_{IN} = \frac{{T}_{g}}{{C}_{g} {\dot{M}}_{g}} ,$$

where T_{g} is the measured exhaust gas temperature, C_{g} is the known specific heat of the exhaust gas 22, and \dot{M}_{g} is the mass flow rate of the exhaust gas 22. The algorithm 100 then proceeds to step 104.

At step 104, host machine 40 solves for the net energy output rate \dot{Q}_{OUT} of the exhaust stream 22 exiting the particulate filter 34, e.g., using temperature model 50. The value \dot{Q}_{OUT} can then be transformed into an output temperature value, i.e., by multiplying by (C_{g}\dot{M}_{g}). Then, E_{OUT}−E_{IN}=\dot{Q}_{OUT}−\dot{Q}_{IN}. This basic energy balance equation can then be applied to determine the total energy transfer with respect to the particulate filter 34.

That is, energy transfer with respect to substrate 35 can be determined using information extracted from the temperature model 50 by the host machine 40, with the temperature model populated using the following equation:

E_{PF,TOTAL}=(E_{PF,OUT}−E_{PF,IN})+E_{SOOT},

where E_{SOOT} may be determined via the equation:

Hv_{CARBON}(\dot{R}_{O2}−\dot{R}_{NO2}),

with Hv_{CARBON} being the heating value of the particulate matter in the particulate filter 34, and with the values \dot{R}_{O2}, \dot{R}_{NO2} representing the soot mass consumption rates through oxidation in the particulate filter. Algorithm 100 then proceeds to step 106.

At step 106, the predicted peak temperature is calculated by host machine 40. Host machine 40 may access models 50 and 60 and extract information such as burn rates and specific heat values, and uses the energy balance equations from the models to calculate the predicted peak temperature, i.e., T_{PF, PEAK} as follows:

$${T}_{PF , PEAK} = {T}_{0} + \frac{( {E}_{PF , TOTAL} ) ( {t}_{ZSOOT} )}{( {C}_{pPF} ) ( {M}_{PF} )} ,$$

where T₀ is the current temperature of the particulate filter 34, C_{pPF} is the specific heat of the substrate 35, and M_{PF} is the mass of the substrate 35. The value t_{ZSOOT} is the time remaining, per the soot model 60, until substantially no soot remains in the particulate filter 34, a value which may be pre-calculated and stored in the soot model using the following equation:

$${t}_{zSOOT} = \frac{{M}_{SOOT}}{\frac{d {M}_{SOOT}}{d T}} = \frac{{M}_{SOOT}}{{η}_{f} P {\dot{M}}_{eng , out} - ( {\dot{R}}_{O 2} - {\dot{R}}_{NO 2} )} .$$

Information may then be extracted from the soot model 60 by host machine 40 in calculating the predicted peak temperature as explained below. In the two equations appearing immediately above, M_{SOOT} is the mass of soot, η_{f} is the filtration efficiency of the particulate filter 34, and P\dot{M} is the accumulation rate of soot or particulate matter, i.e., PM, in the particulate filter.

The predicted peak temperature T_{PF, PEAK}, of the particulate filter 34 at the calculated time t_{ZSOOT} is then determined using the equation appearing immediately above by knowing the properties of the substrate 35 and storing these known or calibrated values in the temperature model 50.

At step 108, the host machine 40 compares the predicted peak temperature (T_{PF, PEAK}) to a calibrated threshold and records a flag reflecting the result, e.g., setting a diagnostic code or a flag of 0 when the threshold is not exceeded, and a different diagnostic code or a flag of 1 when the threshold is exceeded. After the results of the comparison are recorded, the algorithm 100 proceeds to step 110.

At step 110, host machine 40 may execute a preemptive control action when the predicted peak temperature (T_{PF, PEAK}) exceeds the calibrated threshold. As used herein, preemptive control action means a control action executed well before the predicted peak temperature (T_{PF, PEAK}) is realized, such that the control action prevents temperature in the particulate filter 34 from ever reaching the predicted level. One possible preemptive control action is an engine management action such as but not limited to reducing the levels of O2 in the exhaust stream, selective cylinder deactivation, reduction in hydrocarbon injection rate, etc.

Using algorithm 100 and host machine 40 as set forth above, protection modes may be entered only when necessary to protect the particulate filter 34. The calibrated threshold may be determined beforehand via testing and validation for a given vehicle 10 under expected operating conditions to optimize the accuracy of the soot model 60, the temperature model 50, and the algorithm 100. That is, during the design phase the thermal boundaries of the particulate filter 34 are accurately defined, and then subjected to rigorous testing to gain an understanding of the statistical distribution of various failure modes, such as face or internal cracks in the substrate 35.

Approaches such as finite element analysis can be used to gain an understanding of the probability of failure in the lifetime of the particulate filter 34 at a given temperature distribution. Steps may then be taken in the design phase to increase the robustness of the substrate material and optimize the thermal boundaries, with the present method enforcing these well-defined boundaries.

While the best modes for carrying out the invention have been described in detail, those familiar with the art to which this invention relates will recognize various alternative designs and embodiments for practicing the invention within the scope of the appended claims.

1. A vehicle comprising:
an internal combustion engine having an exhaust port;
a particulate filter in fluid communication with the engine via the exhaust port, wherein the particulate filter is regenerable using heat; and
a host machine operable for calculating a predicted peak temperature in the particulate filter, and for automatically executing a control action when the predicted peak temperature exceeds a calibrated threshold;
wherein execution of the control action prevents the peak temperature from being realized.

2. The vehicle of claim 1, the vehicle including a model which estimates filter soot loads and corresponding burn rates, wherein the host machine extracts information from the soot model and uses the information to calculate the predicted peak temperature.

3. The vehicle of claim 1, wherein the host machine automatically executes an engine management action as the control action.

4. The vehicle of claim 1, further comprising a fuel injection device which selectively injects fuel into the exhaust stream to elevate a regeneration temperature of the particulate filter, wherein the control action includes reducing the regeneration temperature by initiating feedback control over an operation of the fuel injection device.

5. The vehicle of claim 1, wherein the host machine generates a diagnostic code as at least part of the control action, with the value of the diagnostic code corresponding to the value of the predicted peak temperature with respect to the calibrated threshold.

6. The vehicle of claim 1, wherein the engine is a diesel engine and the vehicle includes a diesel oxidation catalyst positioned between the engine and the particulate filter.

7. A system for use aboard a vehicle having an internal combustion engine, the system comprising:
a particulate filter in fluid communication with an exhaust port of the engine, wherein the particulate filter is regenerable using heat; and
a host machine operable for calculating a predicted peak temperature in the particulate filter, and for automatically executing a control action when the predicted peak temperature exceeds a calibrated threshold;
wherein execution of the control action prevents the peak temperature from being realized.

8. The system of claim 7, further comprising a model which estimates filter soot loads and corresponding burn rates, wherein the host machine extracts information from the soot model and uses the information to calculate the predicted peak temperature.

9. The system of claim 7, wherein the host machine automatically executes an engine management action as the control action.

10. The system of claim 7, further comprising a fuel injection device adapted to selectively inject fuel into the exhaust stream to elevate a regeneration temperature of the particulate filter, wherein the control action includes reducing the regeneration temperature by initiating feedback control over an operation of the fuel injection device.

11. The system of claim 7, wherein the host machine generates a diagnostic code as at least part of the control action, with the value of the diagnostic code corresponding to the value of the predicted peak temperature with respect to the calibrated threshold.

12. The system of claim 7, wherein the engine is a diesel engine and the system includes a diesel oxidation catalyst positioned between the engine and the particulate filter.

13. A method for use aboard a vehicle having an internal combustion engine, a particulate filter which is regenerable using heat, and a host machine, the method comprising:
calculating a predicted peak temperature in the particulate filter using the host machine; and
automatically executing a control action when the predicted peak temperature exceeds a calibrated threshold;
wherein execution of the control action thereby prevents the peak temperature from being realized.

14. The method of claim 13, wherein the vehicle includes a model which estimates filter soot loads and corresponding burn rates, the method further comprising:
extracting information from the soot model; and
calculating the predicted peak temperature using the information.

15. The method of claim 13, further comprising:
automatically executing an engine management action as the control action.

16. The method of claim 13, the vehicle further comprising a fuel injection device adapted to selectively inject fuel into the exhaust stream to elevate a regeneration temperature of the particulate filter, the method further comprising:
reducing the regeneration temperature by initiating feedback control over an operation of the fuel injection device as at least part of the control action.

17. The method of claim 13, further comprising generating a diagnostic code having a value corresponding to the value of the predicted peak temperature with respect to the calibrated threshold.
